(19) United States
(12) Patent Application Publication
(10) Pub. No.: US 2024/0241929 A1
(43) Pub. Date: Jul. 18, 2024

(54) System and Method for Physical and Virtual World Device Enablement

(71) Applicant: APRIL ELIZABETH ROGERS, Berkeley Lake, GA (US)

(72) Inventor: APRIL ELIZABETH ROGERS, Berkeley Lake, GA (US)

(21) Appl. No.: 18/403,070

(22) Filed: Jan. 3, 2024

Related U.S. Application Data
(60) Provisional application No. 63/438,682, filed on Jan. 12, 2023.

(51) Int. Cl. G06F 21/31; G06F 21/10; G06Q 20/38; G06T 19/00

(52) U.S. Cl. CPC G06F 21/31; G06F 21/1014; G06Q 20/389; G06T 19/00

(57) ABSTRACT

The present invention is a system and method for enablement of corresponding physical and virtual world devices. Specifically, the present invention facilitates the interaction between physical world devices, virtual devices, and augmented devices using blockchain transactions.

### BACKGROUND OF THE INVENTION

### 1. Field of the Invention

The present invention relates generally to virtual world environments. Particularly, the present invention also relates to devices and non-fungible tokens used in virtual world environments.

### SUMMARY OF THE INVENTION

The present invention enables the interaction between physical world devices, virtual devices or augmented devices using blockchain transactions that make up the omniverse.

### Advantages and Differences of Invention Over Known Prior Art

Currently, physical world devices which are controlled through the internet do not take into account being used in an entirely virtual world, or the representation of those objects in a virtual world. Current assemblies do not provide a method to define ownership and provide access to owned devices through a blockchain. The distributed nature and difficulty to fake transactions on the blockchain make it a more secure way to communicate between the virtual world and physical world.

In addition to those described above, the prior art has further disadvantages such as: 1. They do not take into account merging of technology between the physical and virtual worlds to provide an augmented reality environment. 2. They do not use blockchain to secure transactions between the virtual and physical worlds. 3. They do not provide a method to reflect ownership in both physical and virtual worlds.

In addition to production costs, the above-described parts of the prior art have not proven fully satisfactory for meeting the requirements of the market, because the current market has a need to provide ownership in the physical, virtual and combined physical/virtual worlds, communicate between virtual and physical devices securely and provide access, monitor and control physical and virtual devices that the current technology available does not provide.

It is an object of the present invention to meet the requirements of the market and address these disadvantages. It is also an object of the present invention to provide a metaverse enabled device made up of a physical device such as a piece of electronic equipment, electromechanical equipment, device or any physical object that can be equipped with sensors or has processing capabilities that are used in industry as well as private life and can be internet enabled which exists as a physical object that can be interacted with or without the metaverse.

It is a further object of the present invention to provide a virtual device within the metaverse that is the analog to a physical device that can be manipulated and/or controlled or other controlling device that has buttons, switches, levers, etc., that can be manipulated and/or controlled by an avatar with a virtual universe.

It is yet a further object of the present invention to provide a metaverse enabled device which can be an augmented device having any physical device that could have virtual components added to interact with it in an augmented reality environment. These virtual components may be a virtual button that can be seen on a car that can be seen through an augmented reality interface that can be pushed to start a corresponding physical component in the physical life. For example, if the metaverse enabled device is a virtual automobile, then the corresponding physical component in the physical life may be a car in physical life.

The present invention achieves these and other objectives by providing a device or series of devices that exists in the omniverse as a combination of physical, virtual, and augmented devices.

The present invention also achieves these and other objectives by providing a non-fungible token (NFT) is a unique and non-interchangeable unit of data stored on a blockchain used to provide ownership of assets in the physical world as well as the metaverse.

### BRIEF DESCRIPTION OF THE DRAWINGS

FIG. 1 is a flow or process diagram of a method according to one embodiment of the present invention for a metaverse enabled device purchase.

FIG. 2 is a flow or process diagram of a method according to one embodiment of the present invention for a metaverse enabled device access agreements for granting access.

FIG. 3 is a flow or process diagram of a method according to one embodiment of the present invention for a metaverse enabled device access agreements for denying access.

FIG. 4 is a flow or process diagram of a method according to one embodiment of the present invention for a metaverse enabled device manipulation within an augmented or virtual reality.

FIG. 5 is a flow or process diagram of a method according to one embodiment of the present invention for a metaverse enabled device manipulation within the physical world.

FIG. 6 is a diagrammatic representation of an embodiment of a physical device being incorporated as a corresponding virtual device in the virtual world according to the method of the present invention.

### DETAILED DESCRIPTION OF THE INVENTION

A metaverse enabled device according to the present invention is made up of a physical device such as a piece of electronic equipment, electromechanical equipment, device or any physical object that can be equipped with sensors or has processing capabilities that are used in industry as well as private life and can be internet enabled which exists as a physical object we can interact with or without the metaverse.

A virtual device according to the present invention within the metaverse that is the analog to a physical device that can be manipulated and/or controlled or other controlling device that has buttons, switches, levers etc., that can be manipulated and/or controlled by an avatar.

A metaverse enabled device according to the present invention can also be: an augmented device that would be any physical device that could have virtual components added to interact with it in an augmented reality environment. Such as a virtual button that can be seen on a car that can be seen through an augmented reality interface that can be pushed to start the car in physical life.

A device such as this according to the present invention exists in the omniverse as a combination of physical, virtual, and augmented devices.

A non-fungible token (NFT) is a unique and non-interchangeable unit of data stored on a blockchain used to provide ownership of assets in the physical world as well as the metaverse.

A metaverse enabled device is a device manipulated and/or controlled in the physical world, virtual world or in an augmented reality environment would be defined as an NFT owned by the person/avatar.

When a metaverse enabled device is manipulated and/or controlled (for example turned on or off) the device will communicate through the internet to the appropriate crypto exchange providing the NFT information for the NFT that is being interacted with and the type of transaction that was done for that NFT (turned on, turned off, etc). Once this transaction has been completed in the exchange the devices will be notified to ensure their state matches the transaction made.

### Process

Physical devices are purchased in physical world or metaverse through standard exchange of money or cryptocurrency. Cryptocurrency transactions for the purchase of the device can happen in the physical, virtual or augmented realities using the cryptocurrency of the users choice.

The physical device is represented in the metaverse as an NFT. An NFT with said physical device can be metaverse enabled meaning that manipulation of the physical device, virtual device or augmented device will result in the same change in state or manipulation to occur to all corresponding devices. The representation of a metaverse-enabled device does not need to be a perfect analog in all representations of the device, for example a lamp could have three entirely different representations. The physical world representation is the actual device. The virtual or augmented representation of the lamp could be a digital representation of the lamp with the same controls to be manipulated and/or controlled by an avatar or physical world gestures however the virtual or augmented world representation of the lamp could change appearances to match the room or could be enhanced to have different controls easier to manipulate in the virtual or augmented world, in other cases the virtual or augmented representation could just be a set of controls to manipulate the external device.

The ownership of metaverse-enabled devices can be transferred, bought, or sold using standard blockchain transactions. Inherently in the virtual and augmented world only the owner of the metaverse-enabled device can manipulate said device.

The owner of a metaverse-enabled device can give individuals or groups access to the device through access agreements transactions recorded on the blockchain. Access agreements can be initiated by many different means in the virtual world such as one avatar (the owner) handing the device controller to another avatar. Access agreements can be set with an expiration or can be revoked at any time through standard block chain transactions. Access agreements define levels of access or levels of control for that device, these levels can include things like can others grant further access to new individuals or groups, do they have view access, can they manipulate all of the controls or just some, etc.

Special access agreements will be setup when more than one party has control over the agreement, a change by one party can affect the access all individuals have. An example of this type of access agreement would be a service agreement for repair by the manufacturer, this type of agreement would need to include a component where the owner grants certain privileges to the manufacturer to provide service as well the manufacturer providing access to the various service levels they may have. These multi-party access agreements would be maintained through specialized access agreements recorded on the blockchain.

When metaverse enabled devices are manipulated and/or controlled (a button is pushed, a knob turned, a virtual wand is waved, etc) the manipulations are recorded through block chain “action” transactions. Action transactions are sent to all representations of the metaverse enabled device (physical, virtual and augmented) so that the state of all devices are changed. Likewise when certain special actions are performed on a device such as a service provider does a routine inspection or makes a repair in the physical device, these actions will be recorded on the block chain.

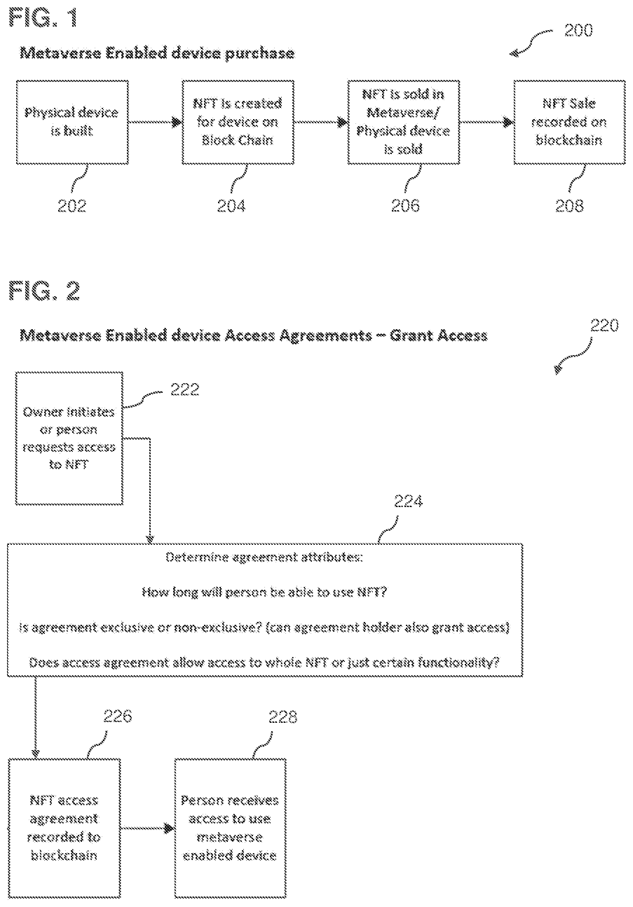

Specifically, FIG. 1 is a flow or process diagram of a method according to one embodiment of the present invention for a purchase of a metaverse enabled device purchase. A first step here includes building a physical device. Afterwards, a second step includes creating an NFT to correspond to the physical device on the block chain. A third step would then include selling the NFT in a virtual world setting or selling the physical world. A fourth step includes recording the NFT sale as a transaction on blockchain.

FIG. 2 is a flow or process diagram of a method according to one embodiment of the present invention for a metaverse enabled device access agreements for granting access. A first step includes having an owner initiating or requesting access of a third-party to the NFT. A second step includes determining the agreement attributes. Such attributes could include how long a person will be able to use the NFT, whether the agreement is exclusive or non-exclusive, whether an agreement holder can also grant further access, and/or whether the agreement allows access to entire device functionality or restricted functionality. A third step may then include recording the NFT access agreement to the blockchain. A fourth step may then include the third-party receiving access to use the metaverse enabled device.

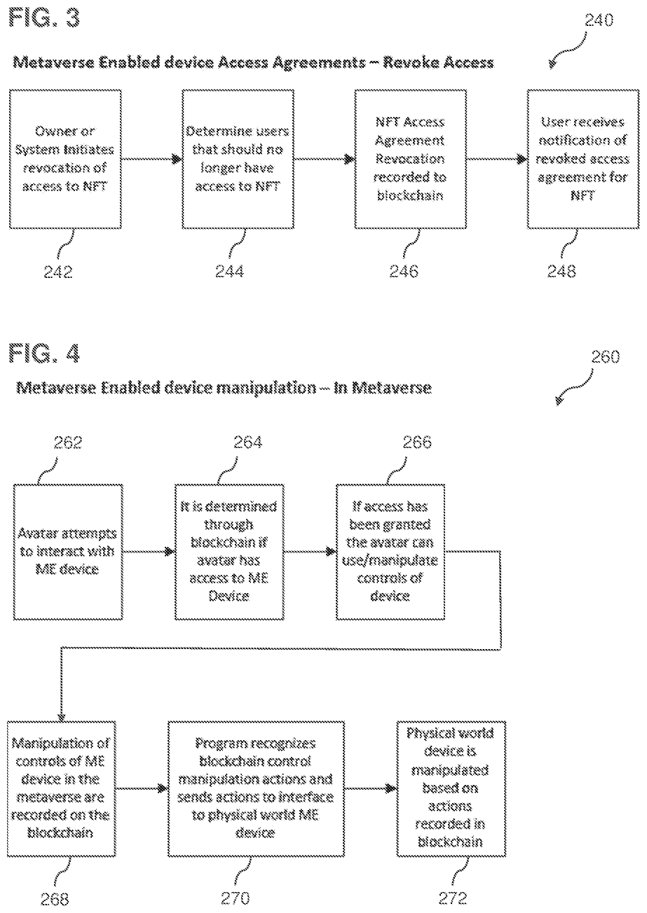

FIG. 3 is a flow or process diagram of a method according to one embodiment of the present invention for a metaverse enabled device access agreement for revoking access. A first step includes having an owner initiating revocation of access of a third-party to the NFT. A second step includes determining which third-party users the agreement should no longer apply to, aka, which third-party users that should no longer have access to the NFT. A third step may then include recording the revocation of the NFT agreement to the blockchain. A fourth step may then include revoking access of the third-party to use the metaverse enabled device. The fourth step may also include notifying the third-party that access to use the metaverse enabled device has been revoked.

FIG. 4 is a flow or process diagram of a method according to one embodiment of the present invention for manipulating a metaverse enabled device within an augmented or virtual reality. In a first step, an avatar attempts to interact with a virtual device. In a second step, the system determines whether the party represented by the avatar should have access to the virtual device via blockchain. In a third step, the system allows manipulation or use of the controls of the device if access has been granted by the owner. If so, the type of attempted manipulation of the controls of the virtual device is then recorded on the blockchain. Finally, the physical world device is then manipulated based on actions recorded in blockchain.

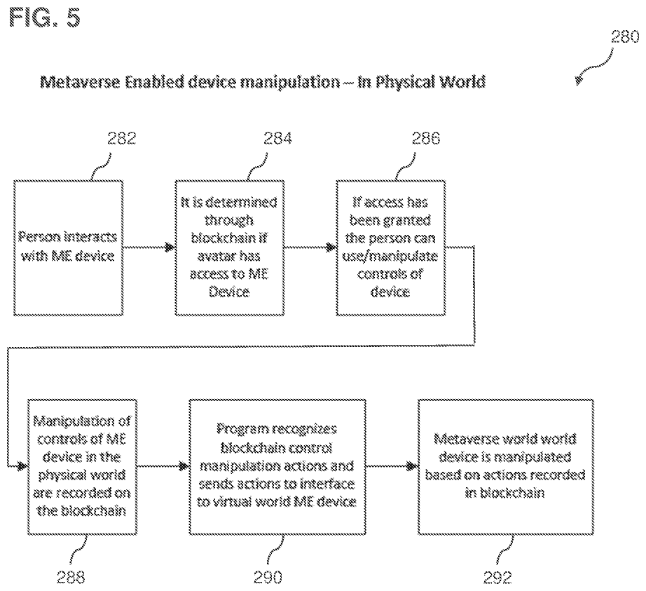

FIG. 5 is a flow or process diagram of a method according to one embodiment of the present invention for a metaverse enabled device manipulation within the physical world. In a first step, an individual interacts with a physical device. In a second step, the system determines whether the individual represented by a specific avatar should have access to a corresponding virtual device via blockchain. In a third step, the system allows manipulation or use of the controls of the corresponding virtual device if access has been granted by the owner. If so, the fourth step includes recording the type of manipulation of the controls of the physical device on the blockchain. Then, the program recognizes the requested blockchain manipulation actions and sends those actions to interface to the virtual device within the virtual world. Finally, the virtual device within the virtual world is then manipulated based on actions recorded in blockchain corresponding to the type of actions which occurred in the physical world.

### Example Embodiment

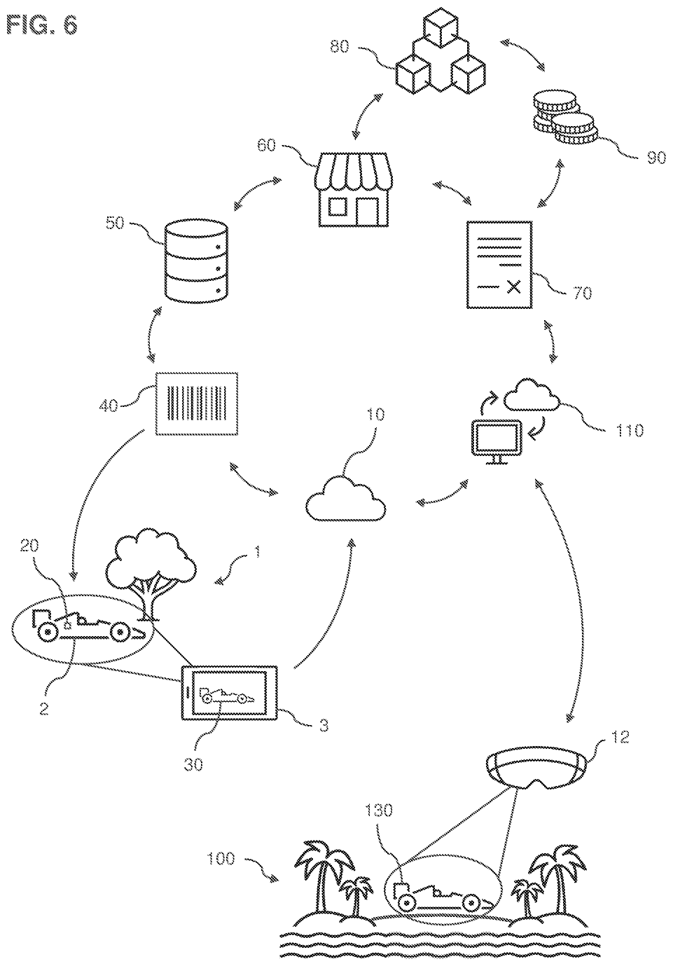

FIG. 6 provides one potential illustration of one embodiment of the present invention. This embodiment of the present invention exists in the physical real world and within the virtual world as a combination of physical, virtual, and augmented devices.

As previously stated, a metaverse enabled device according to the present invention can be made up of a physical device 2 in the physical world 1 such as a piece of electronic equipment, electromechanical equipment, device, or any physical object 2 that can be equipped with sensors 20. Such a device 2 can be equipped with sensors 20 and may have processing capabilities that are used in industry as well as private life. These devices can be internet enabled, but they exist as a physical object we can interact with directly-without a virtual or augmented reality environment 100. In this embodiment, an automobile 2 is the physical device in the physical world 1 that has a corresponding augmented device 130 capable of interacting in an augmented reality environment 100.

As previously stated, a virtual representation of a metaverse-enabled device, the virtual device 130, does not need to be a perfect analog in all respects of the physical device, 2. However, it is possible to create a perfect analog using an electronic recording device 3 such as a digital camera to record real-time representations 30 of the physical device 2. These representations 30 can be uploaded to the cloud 10. Once labeled with the appropriate identifier 40, the virtual device 130 can be connected with the corresponding sensor or controller 20 of the physical device 2. Details regarding the physical device 2 and sensor 20 can be stored within servers 50 accessible via personal cloud storage 10.

Only the owner of the metaverse-enabled device can manipulate the device 130 in the virtual or augmented world 100. The ownership 70 of metaverse-enabled devices can be transferred, bought, or sold using standard blockchain 80 transactions through a standard storefront 60. Non-fungible tokens (NFT) 90 are unique and non-interchangeable units of data stored on a blockchain 80 used to provide proof 70 of ownership of assets 130 in the physical world as well as in the virtual world 100.

When a virtual device 130 is manipulated and/or controlled (for example turned on or off) the interactive device 12 will communicate through the internet 110 to the appropriate crypto exchange 60 providing the NFT information for the NFT 90 that is being interacted with and the type of transaction that was done for that NFT 90 (turned on, turned off, etc). Once this transaction has been completed in the exchange the corresponding physical button 20 of the physical devices 2 will be notified to ensure that the state of the button 20 matches the transaction made. The owner of a metaverse-enabled device can give other individuals or groups access to the device through access agreements 70 which record transactions on the blockchain 80 through the storefront 60.

### LIST OF REFERENCED ELEMENTS

The following reference numbers are adhered to within the specification to refer to those referenced elements within the drawings of the present application.

| | |
|---|---|
| physical world 1 | electronic interface 3 |
| physical device 2 | cloud/internet 10 |
| electronic interface 12 | access step 228 |
| physical button 20 | revoking method 240 |
| representation 30 | initiating step 242 |
| identification 40 | determining step 244 |
| database cloud storage 50 | recording step 246 |
| storefront 60 | revoking step 248a |
| transaction agreement 70 | notifying step 248b |
| blockchain 80 | manipulation method 260 |
| nonfungible token (NFT) 90 | attempting step 262 |
| virtual world 100 | determining step 264 |
| end user gaming device 110 | enabling step 266 |
| virtual device 130 | recording step 268 |
| method of purchase 200 | recognizing step 270 |
| building step 202 | manipulating step 272 |
| creating step 204 | manipulation method 280 |
| selling step 206 | interacting step 282 |
| recording step 208 | determining step 284 |
| method of granting 220 | manipulating step 286 |
| requesting step 222 | recording step 288 |
| attributing step 224 | recognizing step 290 |
| recording step 226 | manipulating step 292 |

### CONCLUSION

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A system capable of facilitating the interaction between the physical world and virtual world, the method comprising:
purchasing a virtual world enabled device;
granting access to the virtual world enabled device;
revoking access to the virtual world enabled device;
manipulating the virtual world enabled device within the virtual world; and
manipulating the physical world device within the physical world.

2. The system of claim 1 wherein the step of purchasing the virtual world enabled device includes building a physical device, creating an NFT which corresponds to the physical device on a blockchain, selling the NFT in a virtual world setting, and recording the NFT sale as a transaction on blockchain.

3. The system of claim 1 wherein the step of granting access to the virtual world enabled device includes initiating access to the NFT, determining preferred access agreement attributes, recording the NFT access agreement to the blockchain, and receiving access to use the virtual world enabled device.

4. The system of claim 1 wherein the step of revoking access to the virtual world enabled device includes initiating revocation, determining which agreement should be revoked, recording the revocation of the NFT agreement to the blockchain, revoking access of use to the virtual world enabled device, and notifying that access of use to the virtual world enabled device has been revoked.

5. The system of claim 1 wherein the step of manipulating the virtual world enabled device within the virtual world includes attempting to interact with the virtual world enabled device, determining whether access to the virtual world enabled device should be granted via blockchain; allowing manipulation of controls of the virtual world enabled device; recording the type of manipulation of the controls of the virtual device on the blockchain, and then manipulating the physical world device based on actions recorded on the blockchain.

6. The system of claim 1 wherein the step of manipulating the physical world device within the physical world includes interacting with the physical device, determining whether access to the virtual world enabled device should be granted via blockchain; allowing manipulation of controls of the virtual world enabled device; recording the type of manipulation of the controls of the physical device on the blockchain, and then manipulating the virtual world enabled device based on actions recorded on the blockchain.
